(19) United States
(12) Patent Application Publication
(10) Pub. No.: US 2015/0138834 A1
(43) Pub. Date: May 21, 2015

(54) LIGHT SOURCE DEVICE AND ELECTRONIC APPARATUS

(71) Applicant: Nikon Corporation, Tokyo (JP)

(72) Inventors: Takeshi YAGI, Tokyo (JP); Motoo Koyama, Tokyo (JP)

(73) Assignee: Nikon Corporation, Tokyo (JP)

(21) Appl. No.: 14/521,092

(22) Filed: Oct. 22, 2014

Related U.S. Application Data
(63) Continuation of application No. PCT/JP2013/062223, filed on Apr. 25, 2013.

(30) Foreign Application Priority Data
Apr. 27, 2012 (JP) 2012-102514

(51) Int. Cl. F21V 8/00

(52) U.S. Cl. CPC G02B 6/0081; G02B 6/0073
USPC 362/611

(57) ABSTRACT

A light source device includes: a light source; a package that houses the light source and has an opening section configured to emit light from the light source; a light reduction unit provided on the opening section and configured to reduce the light emitted from the opening section; and a light guide plate having: an incidence surface configured such that the light reduced by the light reduction unit is incident on the incidence surface; a light guide section configured to guide the light which is incident on the incidence surface; and an emission surface configured to emit the light guided by the light guide section.

### CROSS-REFERENCE TO RELATED APPLICATION

This is a Continuation Application of International Application No. PCT/W2013/62223 filed on Apr. 25, 2013, which claims priority on Japanese Patent Application No. 2012-102514 filed on Apr. 27, 2012, the contents of which are incorporated herein by reference.

### BACKGROUND

1. Field of the Invention

The present invention relates to a light source device and an electronic apparatus.

2. Background

In a mobile electronic apparatus such as a mobile phone, a PDA (Personal Digital Assistant), a notebook personal computer, a portable game machine, and a portable music player, a liquid crystal display device that displays a variety of information and images has been widely employed, and a display region is illuminated from the back surface side of a liquid crystal display panel by using a backlight (a light source device). In the backlight, light from the light source is incident to the lateral surface of a light guide plate to emit planar light from the emission surface (for example, top surface) of the light guide plate, and the liquid crystal display panel is widely illuminated (for example, refer to Japanese Patent Application, Publication No. 2011-44324A).

In a mobile electronic apparatus such as a mobile phone, it is necessary to enlarge a region in which a variety of information and images are displayed without increasing the size of the apparatus. Therefore, the display region is enlarged by narrowing a so-called frame portion which is a peripheral portion of the display region. In addition, it is also required to narrow the frame portion from the viewpoint of improved design of the electronic apparatus.

### SUMMARY

However, in such a narrow frame configuration, since a light source is arranged at the frame portion, the light source becomes close to the display region. Thus, the light amount of a part of the display region, in particular, a region close to the light source becomes excessive, and uneven brightness is formed, which is a deterioration of display performance.

An object of an aspect of the present invention is to provide a light source device and an electronic apparatus capable of avoiding the occurrence of uneven brightness,

According to an aspect of the present invention, there is provided a light source device including: a light source; a package that houses the light source and has an opening section configured to emit light from the light source; a light reduction unit provided on the opening section and configured to reduce the light emitted from the opening section; and a light guide plate having: an incidence surface configured such that the light reduced by the light reduction unit is incident on the incidence surface; a light guide section configured to guide the light which is incident on the incidence surface; and an emission surface configured to emit the light guided by the light guide section.

According to another aspect of the present invention, there is provided an electronic apparatus including: the light source device described above.

According to an aspect of the present invention, it is possible to avoid the occurrence of uneven brightness.

### BRIEF DESCRIPTION OF THE DRAWINGS

FIG. 1 is a diagram showing a configuration of a light source device according to a first embodiment of the present invention.

FIG. 2 is a diagram showing a configuration of part of the light source device according to the embodiment.

FIG. 3 is a diagram showing another configuration of the light source device according to the embodiment.

FIG. 4 is a diagram showing a configuration of part of a light source device according to a second embodiment of the present invention.

FIG. 5 is a cross-sectional view showing a configuration of an electronic apparatus according to a third embodiment of the present invention.

FIG. 6 is a diagram showing another configuration of a light source device according to the present invention.

FIG. 7 is a diagram showing still another configuration of a light source device according to the present invention.

FIG. 8 is a diagram showing still another configuration of a light source device according to the present invention.

FIG. 9 is a diagram showing still another configuration of a light source device according to the present invention.

FIG. 10A is a diagram showing still another configuration of a light source device according to the present invention.

FIG. 10B is a diagram showing still another configuration of a light source device according to the present invention.

FIG. 10C is a diagram showing still another configuration of a light source device according to the present invention.

### DESCRIPTION OF THE EMBODIMENTS

Hereinafter, embodiments of the present invention will be described with reference to the drawings.

In the drawings used for the following description, scales are suitably changed in order to make the size of each member and each unit recognizable.

### First Embodiment

First, a first embodiment of the present invention is described.

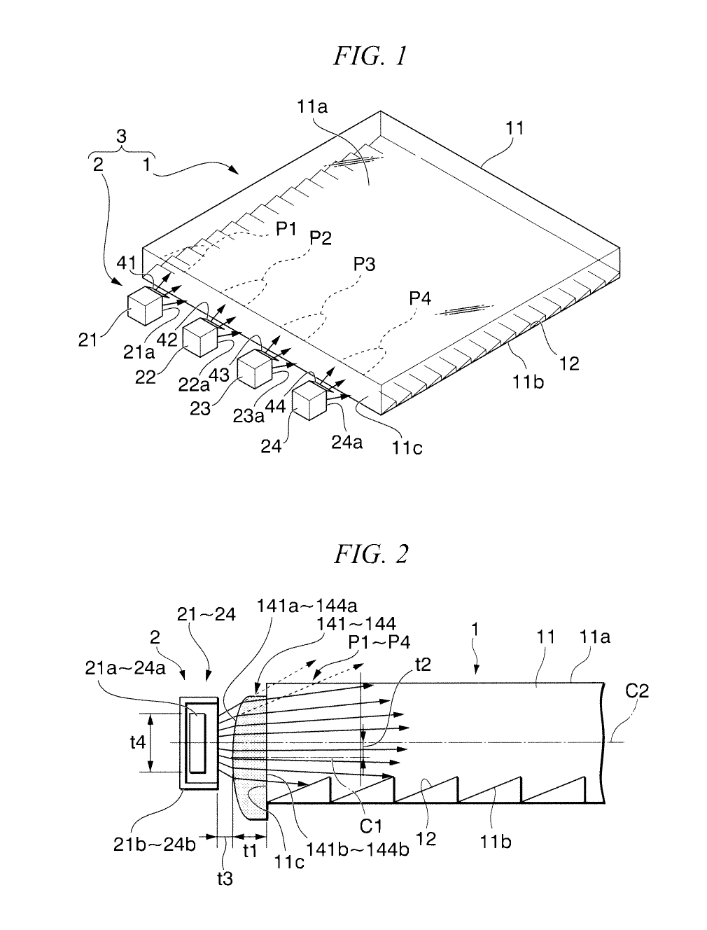

FIG. 1 is a perspective view showing a light source device 3 according to the present embodiment. FIG. 2 is a cross-sectional view showing a configuration of part of the light source device 3. As shown in FIG. 1 and FIG. 2, the light source device 3 includes a light guide plate 1 and a light source 2. The light source device 3 can be used, for example, as a backlight of a liquid crystal display panel or the like.

The light source 2 includes a plurality of light emission devices (light emission device 21, light emission device 22, light emission device 23, and light emission device 24). The light emission device 21, light emission device 22, light emission device 23, and light emission device 24 are arranged in one direction at substantially equal intervals.

As shown in FIG. 2, the light emission device 21 includes a light emitter 21a (light source) and a package 21b that houses the light emitter 21a. The light emission device 22 includes a light emitter 22a (light source) and a package 22b that houses the light emitter 22a. The light emission device 23 includes a light emitter 23a (light source) and a package 23b that houses the light emitter 23a. The light emission device 24 includes a light emitter 24a (light source) and a package 24b that houses the light emitter 24a.

As each of the light emitters 21a to 24a, for example, an LED (Light Emitting Diode) is used. As the LED, a white LED or a pseudo-white LED configured to excite a yellow phosphor using a single-wavelength blue LED to obtain a white color is used. The light source 2 is not limited to an LED, and a variety of light emitters such as a cold-cathode tube may be used. Further, the number and spacing of the light emission devices 21 to 24 are not limited to those shown in FIG. 1 and can be arbitrarily set.

One of opening sections 21c to 24c which is directed to a lateral surface (incidence surface) 11c of a plate-shaped member 11 (light guide section) is formed in each of the packages 21b to 24b. Light emitted from one of the light emitters 21a to 24a is emitted toward the lateral surface (incidence surface) 11c from each of the opening sections 21c to 24c.

The light guide plate 1 is an optical member that emits light from the light source 2 in a planar form. The light guide plate 1 includes the plate-shaped member 11. The plate-shaped member 11 is formed of a material that sufficiently transmits light in the visible light region, such as acrylic resin, polycarbonate, or a variety of glass, in a rectangular shape in planar view. The thickness of the plate-shaped member 11 is, for example, 30 μm to 500 μm. The numerical value is an example, and the invention is not limited thereto.

The plate-shaped member 11 is arranged such that the one lateral surface 11c is parallel to the arrangement direction of the light emission devices 21 to 24 of the light source 2. Therefore, there is a situation in which the lateral surface 11c of the plate-shaped member 11 is arranged to face one of the opening sections 21c to 24c of each of the light emission devices 21 to 24. In the light source 2, blue light emitted from one of the opening sections 21c to 24c is incident on the lateral surface 11c of the plate-shaped member 11.

Accordingly, the lateral surface 11c is an incidence surface of light from the light source 2. Hereinafter, the lateral surface 1c may be referred to as the incidence surface 11c.

The surface (top surface in FIG. 1) of the plate-shaped member 11 is an emission surface 11 a that emits planar light and is formed to be a smooth surface. The emission surface 11a may be applied with a surface treatment for diffusing light. In addition, a diffusion sheet or an optical sheet in which a micro prism is formed (not shown) may be attached to the entire emission surface 11a.

The surface treatment or attachment of the diffusion sheet is used not only for the purpose of adjusting the direction or broadening of light emitted from the emission surface 11a but for the purpose of making the shape of a structure unit 12 (the structure unit 12 is described below) of a back surface 11b to be invisible when the plate-shaped member 11 is seen from the emission surface 11a side.

The structure unit 12 of a saw shape having a plurality of reflection surfaces is formed on the back surface 11b of the plate-shaped member 11. Light introduced from the incidence surface 11c (lateral surface) of the plate-shaped member 11 is guided to the emission surface 11a side by the structure unit 12. The structure unit 12 is formed so that the angle or the size of each reflection surface is changed corresponding to the distance from the incidence surface 11c such that planar light emitted from the emission surface 11a becomes uniform.

The structure unit 12 is not limited to the configuration shown in FIG. 1. For example, the structure 12 may be a structure that guides light to the emission surface 11a by scattering or diffraction other than a structure that reflects light. In addition, instead of the structure unit 12 of a saw shape, a dot having a convex shape or a concave shape may be formed on the back surface 11b. The structure using a dot is configured such that the farther the dot is from the incidence surface 11c, the greater the area of the dot is, and thereby planar light emitted from the emission surface 11a becomes uniform.

In addition to arranging the light source 2 and the light guide plate 1 such that a space is formed between the light source 2 and the light guide plate 1 as shown in FIG. 1 and FIG. 2, the space between the light source 2 and the light guide plate 1 may be filled with a transparent resin or the like. By filling the space between the light guide plate 1 and the light source 2 with a transparent resin or the like, the transparent resin or the like functions as an adhesive material, and the light guide plate 1 and the light source 2 are integrated. The refractive index of the transparent resin may be matched with the refractive index of the plate-shaped member 11 of the light guide plate 1.

Further, the light source device 3 shown in FIG. 1 is configured such that one lateral surface of the light guide plate 1 is the incidence surface 11c; however, the embodiment is not limited thereto. Two or more lateral surfaces of the plate-shaped member 11 may be the incidence surfaces, and the light source 2 may be provided on each of the lateral surfaces.

One of lenses 141 to 144 (light collection unit) that collects part of light emitted from each of the opening sections 21c to 24e is provided on each of the packages 21b to 24b of the light source 2. As the lenses 141 to 144, for example, a cylindrical lens formed by using a resin material such as polycarbonate is used.

As shown in FIG. 2, one of the lenses 141 to 144 includes each of curved surfaces 141a to 144a and each of flat surfaces 141b to 144b. One of the lenses 141 to 144 is arranged such that each of the curved surfaces 141a to 144a is directed to the light source 2. The flat surfaces 141b to 144b of the lenses 141 to 144 are attached to the incidence surface 11c of the light guide plate 11.

Each of the lenses 141 to 144 is formed such that the thickness t1 is, for example, about 0.4 mm and is formed such that the curvature radius is, for example, about 1 mm to 3 mm. The lenses 141 to 144 are arranged such that an optical axis C1 is shifted to the back surface 11b side by a predetermined shift amount t2 (for example, 0.3 mm or less) relative to a central axis C2 of the light guide plate 1.

One of the lenses 141 to 144 is arranged to form a gap between the one of the lenses 141 to 144 and each of the light emission devices 21 to 24 having a predetermined distance t3 (for example, about 0.2 mm). Further, a light emission surface height t4 of the light emitter 21a is formed to about 0.46 mm. Each of the numerical values described above is just an example, and each of the dimensions may be different from the numerical value described above.

In the above configuration, for example, when the lenses 141 to 144 are not provided, light emitted from one of the opening sections 21c to 24c toward the emission surface 11a (shown by a dashed line in FIG. 2) generates each of excessive light amount regions P1 to P4 on a portion of the emission surface 11a, the portion being close to the incidence surface 11c. The excessive light amount regions P1 to P4 are regions which can be recognized as having high brightness when seen by the human eye.

Accordingly, when the excessive light amount regions P1 to P4 are formed, the human eye recognizes that uneven brightness occurs.

On the other hand, in the present embodiment, since the lenses 141 to 144 are provided, light emitted from one of the opening sections 21c to 24c of the light source 2 toward each of the excessive light amount regions P1 to P4 is bent by each of the lenses 141 to 144 toward the inside of the plate-shaped member 11. Accordingly, the formation of the excessive light amount regions P1 to P4 in the emission surface 11a is avoided, and it is possible to avoid the occurrence of uneven brightness.

As described above, according to the present embodiment, the light source device 3 includes: the light emitters 21a to 24a; the packages 21b to 24b, one of which houses each of the light emitters 21a to 24a and has each of the opening sections 21c to 24c, the each of the opening sections 21c to 24c being directed in the direction of the incidence surface 11c of the plate-shaped member 11 and emitting light from each of the light emitters 21a to 24a; and the lenses 141 to 144 as a light amount adjusting unit, one of which is provided on each of the opening sections 21c to 24c and adjusts the amount of the light emitted from each of the opening sections 21c to 24c.

Therefore, light emitted from one of the opening sections 21c to 24c of the light source 2 toward each of the excessive light amount regions P1 to P4 is bent by each of the lenses 141 to 144 toward the inside of the plate-shaped member 11. Accordingly, the formation of the excessive light amount regions P1 to P4 in the emission surface 11a is avoided. Thereby, it is possible to avoid the occurrence of uneven brightness.

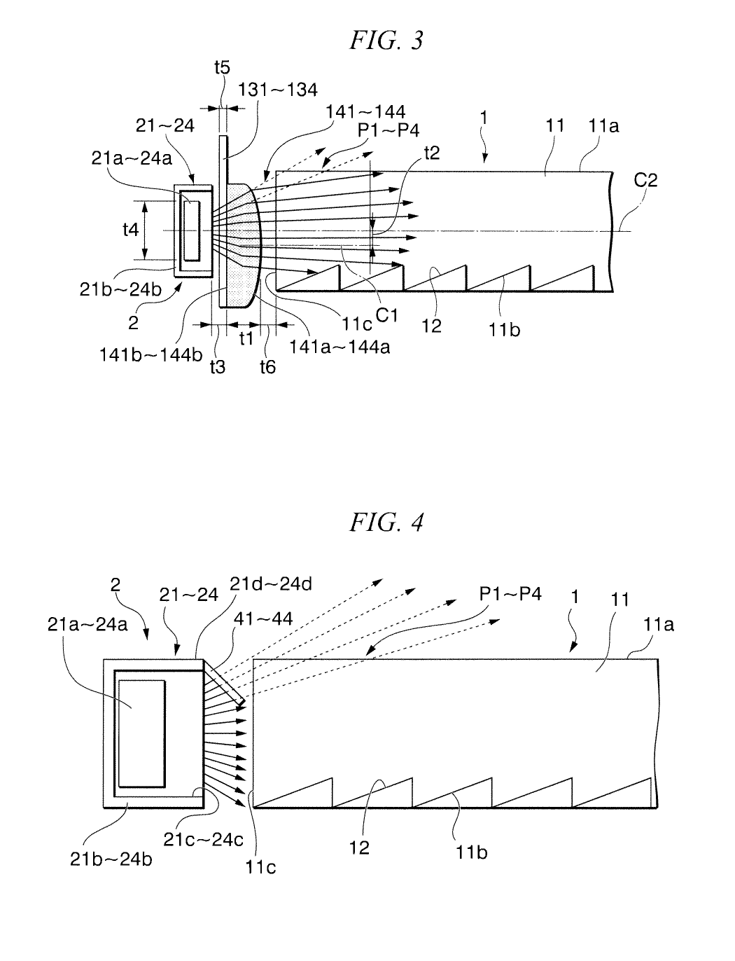

In the present embodiment, for example, as shown in FIG. 3, the lenses 141 to 144 may be arranged between the light source 2 and the light guide plate 1 in a state where one of the lenses 141 to 144 adheres to each of adhesion layers 131 to 134.

In the configuration shown in FIG. 3, the lenses 141 to 144 are arranged such that the curved surfaces 141a to 144a are directed to the incidence surface 11c of the light guide plate 1. One of the flat surfaces 141b to 144b of each of the lenses 141 to 144 is directed to the light source 2 and is attached to each of the adhesion layers 131 to 134. In this configuration, the light source 2 is arranged to face the adhesion layers 131 to 134.

The spacing t3 between the light source 2 and one of the flat surfaces 141b to 144b of each of the lenses 141 to 144 is formed, for example, to about 0.2 mm. A thickness t5 of each of the adhesion layers 131 to 134 is formed, for example, to about 0.1 mm. Accordingly, in FIG. 3, a state where a gap (distance of about 0.1 mm) between the light source 2 and each of the adhesion layers 131 to 134 is formed is shown. For example, the adhesion layers 131 to 134 may be attached to the light source 2.

Even in this case, since the adhesion layers 131 to 134 and the lenses 141 to 144 are provided, light emitted from one of the opening sections 21c to 24c of the light source 2 toward each of the excessive light amount regions P1 to P4 is bent by each of the lenses 141 to 144 toward the inside of the plate-shaped member 11. Accordingly, the formation of the excessive light amount regions P1 to P4 in the emission surface 11a is avoided, and it is possible to avoid the occurrence of uneven brightness,

### Second Embodiment

Next, a second embodiment of the present invention is described.

FIG. 4 is a cross-sectional view showing a configuration of part of the light source device 3 according to the present embodiment.

As shown in FIG. 4, one of light shield units 41 to 44 (light reduction unit) that shields part of light emitted from each of the opening sections 21c to 24c is provided on each of the packages 21b to 24b. As the light shield units 41 to 44, it is possible to use, for example, a member having a plate shape and having a surface on which a metal thin film of a high light absorption rate such as chrome is formed or the like.

One of the light shield units 41 to 44 is provided so as to protrude toward the light guide plate 1 from each of top surfaces 21d to 24d of each of the packages 21b to 24b. One of the light shield units 41 to 44 is arranged to tilt toward each of the opening sections 21c to 24c relative to the direction parallel to each of the top surfaces 21d to 24d of each of the packages 21b to 24b. By adjusting the tilt of one of the light shield units 41 to 44, it is possible to adjust the light shield amount of light emitted from each of the opening sections 21c to 24c.

In the above configuration, for example, when the light shield units 41 to 44 are not provided, light emitted from one of the opening sections 21c to 24c toward the emission surface 11a (shown by a dashed line in FIG. 4) generates each of excessive light amount regions P1 to P4 on a portion of the emission surface 11a, the portion being close to the incidence surface 11c. The excessive light amount regions P1 to P4 are regions which can be recognized as having high brightness when seen by the human eye. Accordingly, when the excessive light amount regions P1 to P4 are formed, the human eye can recognize that uneven brightness occurs.

On the other hand, in the present embodiment, since the light shield units 41 to 44 are provided, light emitted from one of the opening sections 21c to 24c of the light source 2 toward each of the excessive light amount regions P1 to P4 is shielded by each of the light shield units 41 to 44. Accordingly, the formation of the excessive light amount regions P1 to P4 in the emission surface 11a is avoided, and it is possible to avoid the occurrence of uneven brightness.

As described above, according to the present embodiment, the light source device 3 includes: the light emitters 21a to 24a (light source); the packages 21b to 24b, one of which houses each of the light emitters 21a to 24a and has each of the opening sections 21c to 24c, the each of the opening sections 21c to 24c being directed in the direction of the incidence surface 11c of the plate-shaped member 11 and emitting light from each of the light emitters 21a to 24a; and the light shield units 41 to 44 as a light amount adjusting unit (light reduction unit that reduces light), one of which is provided on each of the opening sections 21c to 24c and adjusts the amount of the light emitted from each of the opening sections 21c to 24c.

Therefore, light emitted from one of the opening sections 21c to 24c of the light source 2 toward each of the excessive light amount regions P1 to P4 is shielded by each of the light shield units 41 to 44. Accordingly, the formation of the excessive light amount regions P1 to P4 in the emission surface 11a is avoided. Thereby, it is possible to avoid the occurrence of uneven brightness.

### Third Embodiment

Next, a third embodiment of the present invention is described.

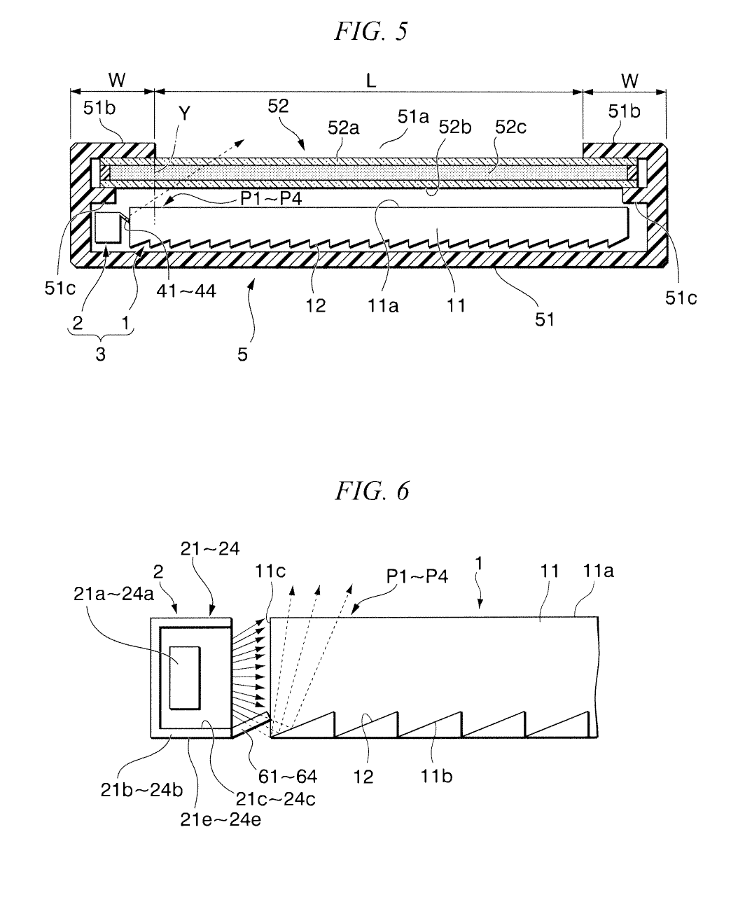

FIG. 5 is a cross-sectional view showing a configuration of an electronic apparatus 5 according to the present embodiment. The electronic apparatus 5 is a portable liquid crystal display device. The electronic apparatus 5 includes a housing 51. The housing 51 includes an aperture section 51a having a width L surrounded by a frame section 51b having a width W and houses the light source device 3 and a liquid crystal panel 52 inside the housing 51. In the present embodiment, the light source device 3 is used as a backlight of the liquid crystal panel 52.

The liquid crystal panel 52 is configured by a glass substrate 52a on the front surface side which includes an individual electrode, a glass substrate 52b on the back surface side which includes a common electrode, and a liquid crystal layer 52c interposed between the glass substrate 52a and the glass substrate 52b. Further, the liquid crystal panel 52 is held by the housing 51 in a state where the peripheral portion of the liquid crystal panel 52 is interposed between the frame section 51b and a rib 51c. Thereby, the area having the width L of the aperture section 51a is used as the display region of the liquid crystal panel 52.

The liquid crystal panel 52 includes a polarization film (not shown) arranged to interpose the glass substrates 52a, 52b, a driver (not shown) for driving the liquid crystal, or the like. As the liquid crystal panel 52, a variety of known liquid crystal panels in addition to the liquid crystal panel shown in the drawing is used.

The light source device 3 is arranged on the glass substrate 52b side of the liquid crystal panel 52 in the housing 51 such that the emission surface 11a of the light guide plate 1 faces the liquid crystal panel 52. In this case, as shown in FIG. 5, the light source 2 is arranged in the area having the width W, on the back side of the frame section 51b. The light guide plate 1 is arranged in a state where the end portion is set into the back side of the frame section 51b such that part of the light guide plate 1 is positioned on the boundary Y between the area having the width L and the area having the width W. Thereby, the light reduction region on the emission surface 11a is arranged at a position which intersects with the boundary Y.

In the electronic apparatus 5 described above, when the light source 2 is turned on, light introduced into the light guide plate 1 from the incidence surface 11c is guided to the emission surface 11a by the structure unit 12 of the back surface to emit as planar light from the emission surface 11a, and the liquid crystal panel 52 is illuminated from the back surface side with the planar light. At this time, since part of light emitted from the light source 2 is shielded by the light shield units 41 to 44, the formation of the excessive light amount regions P1 to P4 is avoided, and the liquid crystal panel 52 is illuminated in a state where uneven brightness on the emission surface 11 a is avoided.

As described above, according to the present embodiment, since the light source device 3 capable of avoiding the occurrence of uneven brightness is used, uneven brightness of illumination light with which the liquid crystal panel 52 is illuminated is avoided. Therefore, in a configuration in which the light source device 3 is used as a backlight, it is possible to reduce display unevenness of the liquid crystal panel 52.

The technical range of the invention is not limited to the above embodiment, and changes can be appropriately added without departing from the scope of the invention.

For example, as shown in FIG. 6, one of light shield units 61 to 64 (light reduction unit) having the same configuration as each of the light shield units 41 to 44 of the embodiment described above may be arranged on each of the bottom surfaces 21e to 24e sides of each of the packages 21b to 24b. In this case, it is possible to shield part of light emitted from each of the opening sections 21c to 24c toward the back surface 11b side of the plate-shaped member 11.

When one of the light shield units 61 to 64 is not provided on each of the bottom surfaces 21e to 24e sides of each of the packages 21b to 24b, as shown by a dashed line in FIG. 6, light emitted from each of the opening sections 21e to 24c toward the back surface 11b of the plate-shaped member 11 is reflected toward the emission surface 11a by the reflection surface of the structure unit 12, and therefore excessive light amount regions P1 to P4 are formed on the emission surface 11a.

On the other hand, by providing the light shield units 61 to 64, it is possible to shield light emitted from each of the opening sections 21c to 24c toward the back surface 11b of the plate-shaped member 11, and therefore it is possible to avoid the formation of the excessive light amount regions P1 to P4. Both of the light shield units 41 to 44 of the above embodiment and the light shield units 61 to 64 in FIG. 6 may be provided.

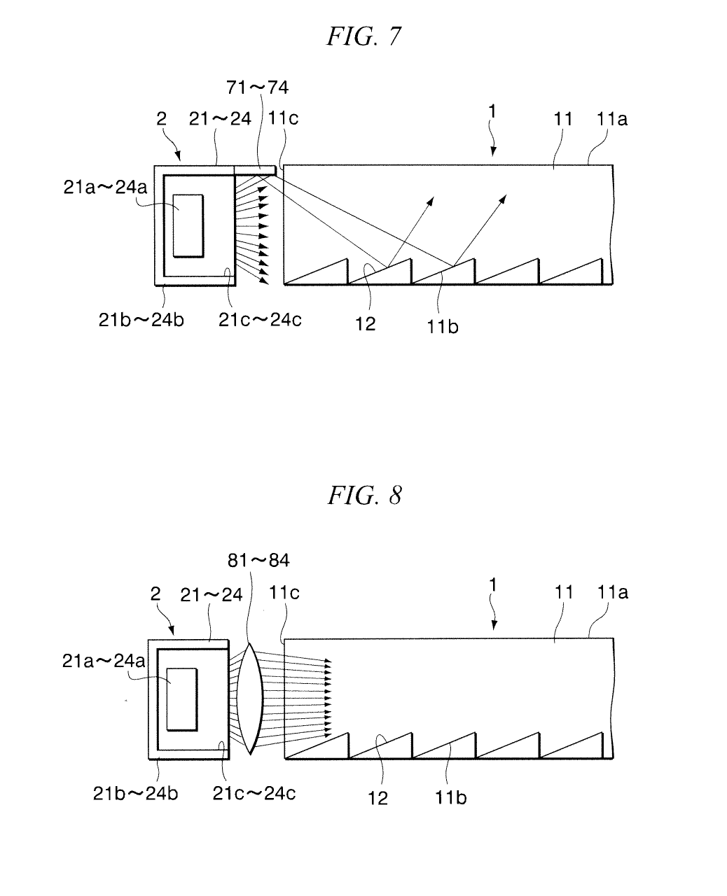

Further, for example, as shown in FIG. 7, instead of the light shield units 41 to 44, reflection units 71 to 74 may be provided. According to this configuration, part of light emitted from one of the opening sections 21c to 24c toward the emission surface 11a of the plate-shaped member 11 is reflected by each of the reflection units 71 to 74, arrives at the back surface 11b, is reflected by the reflection surface of the structure unit 12, and is emitted from a portion far away from the emission surface 11c. Therefore, the formation of the excessive light amount region as described above is avoided.

Further, for example, as shown in FIG. 8, instead of the light shield units 41 to 44, light collection units 81 to 84 may be provided. According to this configuration, it is possible to collect light which is emitted from one of the opening sections 21c to 24c while diffusing toward the incidence surface 11c of the plate-shaped member 11. Therefore, the light travels toward a region between the emission surface 11a and the back surface 11b. Thus, it is possible to avoid the light traveling toward a region on the incidence surface 11 c side of the emission surface 11a.

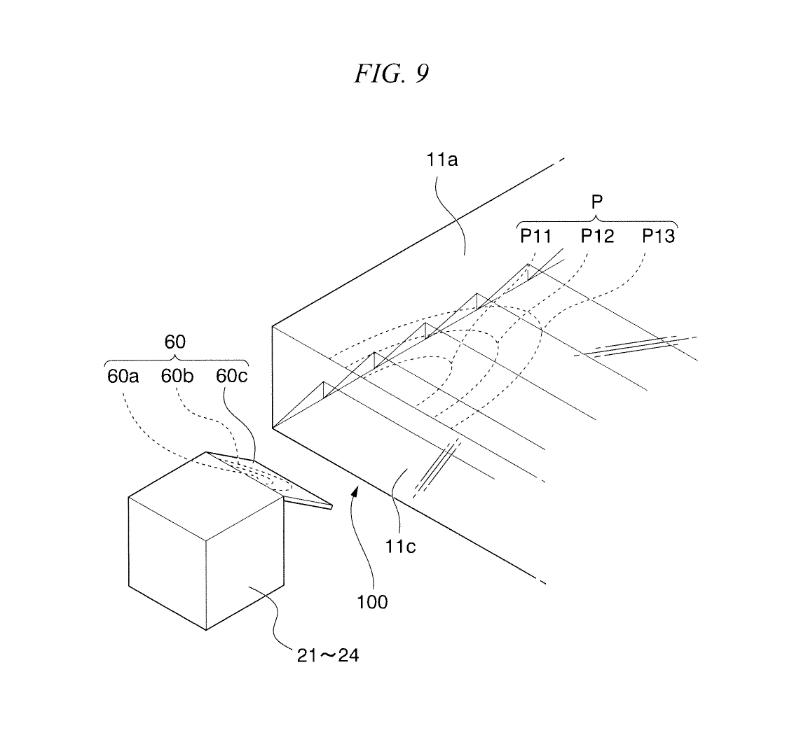

FIG. 9 is a perspective view showing a light guide plate 100 according to still another embodiment.

In the emission surface 11a, the brightness in an excessive light amount region P is not uniform. and the brightness is decreased in accordance with the position being farther from the light source 2, Accordingly, in the uniform light shield units 41 to 44 as shown in FIG. 4, there may be a case where, for example, a portion through which large amount of light is transmitted or a portion in which transmission is suppressed beyond necessity occurs, and uneven brightness remains in the excessive light amount region P. In particular, such a case easily occurs when the excessive light amount region P is large.

On the other hand, in the light guide plate 100 shown in FIG. 9, the excessive light amount region P is divided into a high brightness part P11, a middle brightness part P12, and a low brightness part P13 in this order from the region close to the incidence surface 11c (close to the light source), and a light reduction unit (light amount adjusting unit) 60 which is divided into a high light reduction unit 60a, a middle light reduction unit 60b, and a low light reduction unit 60c is formed such that one of the units 60a to 60c corresponds to each of the parts P11 to P13. Each of the units 60a to 60c of the light reduction unit 60 is formed of a material which reduces the amount of transmission light.

Thereby, the amount of light which is transmitted through the high light reduction unit 60a is greatly restricted, and the amount of light which is transmitted through the middle light reduction unit 60b and the low light reduction unit 60c increases in this order. Thus, the amount of transmission light in the excessive light amount region P is changed in a step-by-step manner. In this way, by dividing the light reduction unit 60 and finely adjusting the light amount, uneven brightness in the excessive light amount region P is avoided, and furthermore, uneven brightness in the entire emission surface 11a is avoided. In particular, the light reduction unit 60 is advantageous for avoiding uneven brightness when the excessive light amount region P is large.

As the high light reduction unit 60a, the middle light reduction unit 60b, and the low light reduction unit 60c, for example, a type of the light reduction unit which transmits part of light and reflects the rest of the light is used. Alternatively and/or additionally, a type of the light reduction unit which transmits part of light and absorbs the rest of the light may be used. In addition, the light reduction unit 60 shown in FIG. 9 is formed to be divided into three regions; however, the embodiment is not limited thereto. The light reduction unit 60 may be formed to be divided into two regions or four or more regions.

As the light reduction unit 60, a light reduction unit that smoothly changes the amount of transmitted light may be used. The light guide plate 100 shown in FIG. 9 has a structure unit on the back surface side of the plate-shaped member 11 similarly to the light guide plate 1 shown in FIG. 1 and FIG. 2.

Further, the light guide plate 100 shown in FIG. 9 and a variety of light sources arranged on the incidence surface 11 c side of the light guide plate 100 may be combined as the light source device. Further, this light source device may be used instead of the light source device 3 shown in FIG. 5 to thereby provide the electronic apparatus.

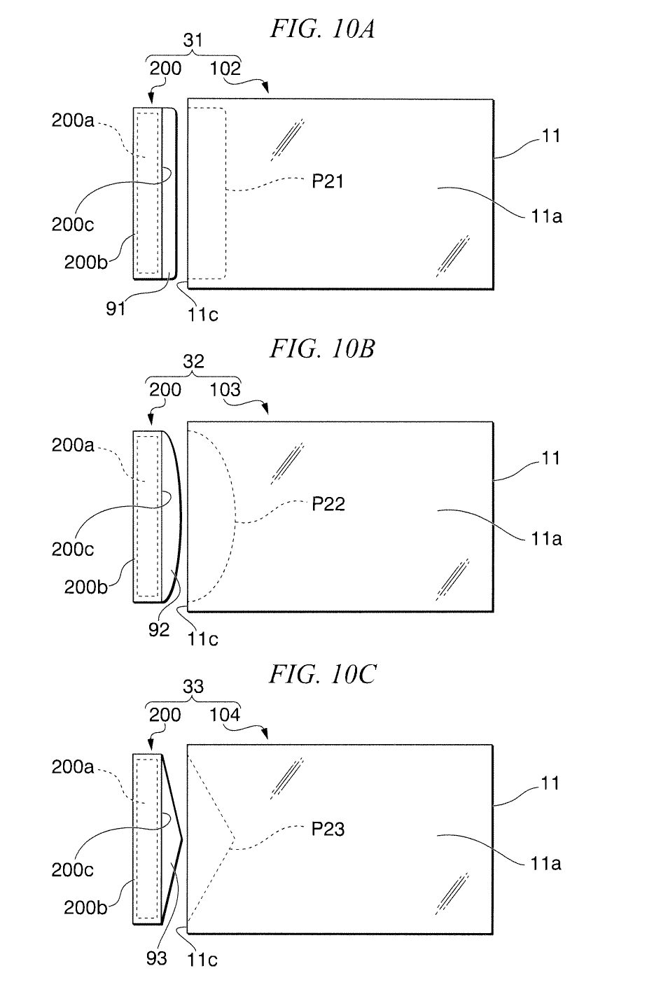

One of FIGS. 10A to 10C is a plan view showing each of light guide plates 102, 103, 104 and each of light source devices 31, 32, 33 according to still another embodiment. The plate-shaped member 11 in each of FIGS. 10A to 10C is the same as that shown in FIG. 1, and the description of the member is omitted.

In FIG. 10A, FIG. 10B, and FIG. 10C, a cold-cathode tube is used as a light source 200. In the present embodiment, the light source 200 is formed such that the longitudinal direction of the light source 200 is parallel to the incidence surface 11c of the light guide plate 102. The light source 200 has a configuration in which a package 200b houses a cold-cathode tube 200a as a light emitter. The package 200b is provided with an opening section 200c. The opening section 200c is directed to the incidence surface 11c.

In the light guide plate 102 of FIG. 10A, when an excessive light amount region P21 is formed in a band shape on the emission surface 11a, a band-shaped light shield unit (light reduction unit, light amount adjusting unit) 91 which corresponds to the excessive light amount region P21 is formed. The light shield unit 91 is formed along the longitudinal direction of the package 200b. Similarly to the above embodiment, the attachment angle of the light shield unit 91 relative to the package 200b is adjustable. By adjusting the attachment angle, it is possible to adjust a light shield region by the light shield unit 91.

In the light guide plate 103 of FIG. 10B, when an excessive light amount region P22 is formed in a shape having a curved boundary (part of a circular shape or an elliptical shape) on the emission surface 11a, a light shield unit (light reduction unit, light amount adjusting unit) 92 having a shape which corresponds to the excessive light amount region P22 is formed. The light shield unit 92 is attached to the package 200b such that a portion formed in a circular shape protrudes from the package 200b toward the light guide plate 103. Similarly to the light shield unit 91 described above, the attachment angle of the light shield unit 92 relative to the package 200b is adjustable. By adjusting the attachment angle, it is possible to adjust a light shield region by the light shield unit 92.

In the light guide plate 104 of FIG. 10C, when an excessive light amount region P23 is formed in a substantially triangular shape on the emission surface 11a, a light shield unit (light reduction unit, light amount adjusting unit) 93 having a substantially triangular shape which corresponds to the excessive light amount region P23 is formed. The light shield unit 93 is attached to the package 200b such that a portion which corresponds to the vertex of the triangle protrudes from the package 200b toward the light guide plate 103. Similarly to the light shield unit 91 and the light shield unit 92 described above, the attachment angle of the light shield unit 93 relative to the package 200b is adjustable. By adjusting the attachment angle, it is possible to adjust a light shield region by the light shield unit 93.

In FIG. 10A, the light guide plate 102 and the light source 200 form the light source device 31. In FIG. 10B, the light guide plate 103 and the light source 200 form the light source device 32. In FIG. 10C, the light guide plate 104 and the light source 200 form the light source device 33. The light source devices 31, 32, 33 are used instead of the light source device 3 of the electronic apparatus 5 shown in FIG. 5.

FIGS. 10A to 10C are described using an example in which the light source 200 is a cold-cathode tube; however, the excessive light amount regions P21 to P23 as shown in FIGS. 10A to 10C may occur, for example, when the light emission device 21 and the like as shown in FIG. 1 are arranged in a narrow spacing or the like. In such a case, one of the light shield units 91 to 93 can be formed for each of the excessive light amount regions P21 to P23.

FIGS. 10A to 10C are described using an example in which each of the light shield units 91 to 93 is used as the light amount adjusting unit; however, the light transmittance may be changed in the same manner as the light reduction unit 60 shown in FIG. 9.

Hereinbefore, the embodiments of the invention are described in detail with reference to the accompanying drawings, but specific configurations are not limited to the embodiments and include a design or the like made in a range without departing from the scope of the invention.

For example, the embodiments described above may be combined. Several types of light amount adjusting units may be provided on one light guide plate by appropriately combining the lenses 141 to 144 of FIG. 2, the lenses 141 to 144 of FIG. 3, the light shield units 41 to 44 of FIG. 4, the light shield units 61 to 64 of FIG. 6, the reflection units 71 to 74 of FIG. 7, the light collection units 81 to 84 of FIG. 8, the light reduction unit 60 of FIG. 9, one of the light shield units 91 to 93 of each of FIGS. 10A to 10C, and the like.

1. A light source device comprising:
a light source;
a package that houses the light source and has an opening section configured to emit light from the light source;
a light reduction unit provided on the opening section and configured to reduce the light emitted from the opening section; and
a light guide plate having:
an incidence surface configured such that the light reduced by the light reduction unit is incident on the incidence surface;
a light guide section configured to guide the light which is incident on the incidence surface; and
an emission surface configured to emit the light guided by the light guide section.

2. The light source device according to claim 1, wherein
the light reduction unit reduces the light by shielding part of the light.

3. The light source device according to claim 1, wherein
the light reduction unit is configured to include a metal.

4. The light source device according to claim 1, wherein
the incidence surface faces the opening section.

5. The light source device according to claim 1, comprising:
as the light reduction unit, a light collection unit configured to collect the light emitted from the opening section.

6. The light source device according to claim 1, wherein
the light reduction unit reduces the amount of the light which travels toward the emission surface of the light guide plate, the light being part of the light emitted from the opening section.

7. An electronic apparatus comprising: the light source device according to claim 1.
